(19) United States
(12) Patent Application Publication
(10) Pub. No.: US 2011/0115415 A1
(43) Pub. Date: May 19, 2011

(54) Low ozone ratio, high-performance dielectric barrier discharge reactor

(76) Inventor: Kun-Liang Hong, Chungho City (TW)

(21) Appl. No.: 12/591,278

(22) Filed: Nov. 16, 2009

(51) Int. Cl. H01J 7/00; H01J 1/02

(52) U.S. Cl. 315/326; 313/309

(57) ABSTRACT

A dielectric barrier discharge reactor made in the form of a module formed of two electrode panels that are vertically arranged in a parallel manner each having a plurality of metal discharge needles and a meshed treatment unit set between the electrode panels in a parallel manner. The meshed treatment unit includes a substrate having a size equal to the electrode panels, and a metal catalyst prepared from gold, silver, platinum, nickel, manganese, chrome or their combination and coated on the substrate. The dielectric barrier discharge reactor is practical for home or public space application to purify air.

### BACKGROUND OF THE INVENTION

1. Field of the Invention

The present invention relates to high-voltage discharge technology and more particularly, to a low ozone ratio, high-performance dielectric barrier discharge reactor.

2. Description of the Related Art

Conventional discharge reactors commonly utilize two discharge electrodes for discharging a high voltage to kill microbes and to decompose volatile organic compounds upon connection of AC or DC power supply. Industrial voltages are generally controlled within 5000V to avoid generation of high concentration ozone during the discharging process. The two discharge electrodes of a discharge reactor may be made in the form of two flat panels, the form of one flat panel and one needle, the form of one needle and one ring. Having the two discharge electrodes made in different shapes is for the sake of enhancing discharge efficiency and reducing the production of ozone. A discharge reactor using two different shapes of discharge electrodes can achieve a better discharge efficiency and reduce the production of ozone, however its microbe killing and volatile organic compound decomposing performance is still not good enough. In order to enhance the microbe killing and volatile organic compound decomposing performance, the applied voltage may be increased to several tends of thousands voltage or several hundred thousand voltage. However, increasing the applied voltage relatively increases the concentration of ozone. It is not easy to reduce the concentration of ozone simply by means of changing the shape of the discharge electrodes. A manganese dioxide module may be added to a discharge reactor to decompose generated ozone, reducing the ozone concentration. However, adding a manganese dioxide module to a discharge reactor relatively increases the dimension of the discharge reactor. Further, a manganese dioxide module has a short service life and environmental protection problems. People are trying hard to reduce ozone concentration in the air, avoiding harmful effect of a high ozone concentration on animal and human respiratory system.

### SUMMARY OF THE INVENTION

The present invention has been accomplished under the circumstances in view. It is one object of the present invention to provide a dielectric barrier discharge module and its fabrication method, which effectively kills microbes and decomposes volatile organic compounds and depresses the formation of ozone.

To achieve these and other objects of the present invention, a high voltage is applied to two electrode panels that are arranged at two sides of a meshed treatment unit in a parallel manner. At this time, high voltage energy is discharged through metal discharge needles between the two electrode panels. The discharged energy goes out of the metal discharge needles of the electrode panels through the meshed treatment unit to ionize benzene and formaldehyde in the air, causing oxidation of negative ions rapidly. After oxidation, these substances are joined to the air and reduced into oxygen, water and carbon dioxide. Further, an electric field is formed between the two electrode panels. Subject to the induction of the electric field, the metal catalyst at the meshed treatment unit is caused to generate metal ions that are attached to airborne particles, which are then electrically attracted to a charged collector plate, and therefore the concentration of formaldehyde, benzene, ammonia and many other toxic or harmful volatile organic compounds in air is greatly reduced.

Further, the metal catalyst at the meshed treatment unit is caused to generate metal ions upon formation of an electric field between the two electrode panels. The metal ions are attached to airborne particles, improving the quality of the surrounding air. During point-to-point energy discharge, the meshed treatment unit suppresses ozone formation. Because the oxidization power of negative ions is stronger than ozone, the invention greatly improves decomposition of volatile organic compounds.

Further, the area ratio between the cross section of the module of the structural design of the two electrode panels and the meshed treatment unit and the cross sectional area of the air passage allows flowing of a big amount of air through the meshed treatment unit between the two electrode panels. Thus, the applied voltage can be lowered and the air treating capacity can be increased.

### BRIEF DESCRIPTION OF THE DRAWINGS

FIG. 1 is a schematic drawing showing a dielectric barrier discharge module constructed according to the present invention.

FIG. 2 is an exploded view of a dielectric barrier discharge reactor according to the present invention.

FIG. 3 illustrates the structure of the electrode panels for the dielectric barrier discharge reactor according to the present invention.

FIG. 4 is a schematic structural view of the meshed treatment unit for the dielectric barrier discharge reactor according to the present invention.

FIG. 4-1 is a sectional view of the metal substrate of the meshed treatment unit according to the present invention.

FIG. 5 is an elevational view of an air purifier according to the present invention.

### DETAILED DESCRIPTION OF THE PREFERRED EMBODIMENT

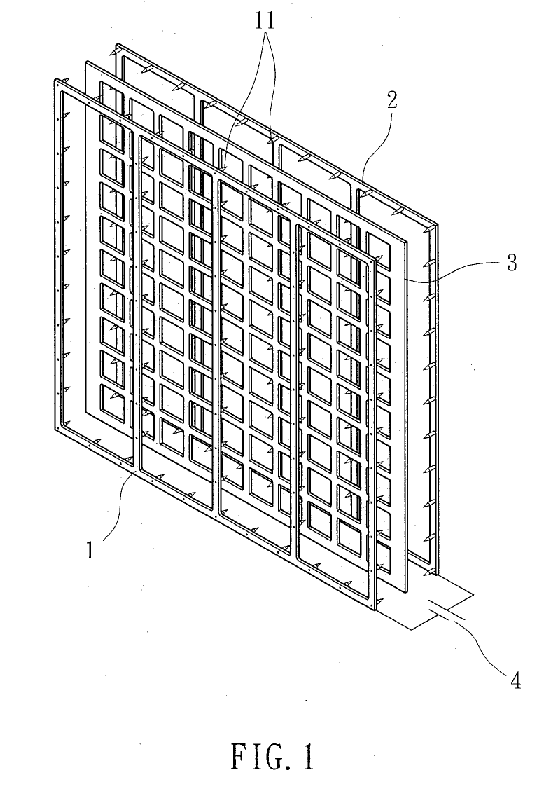

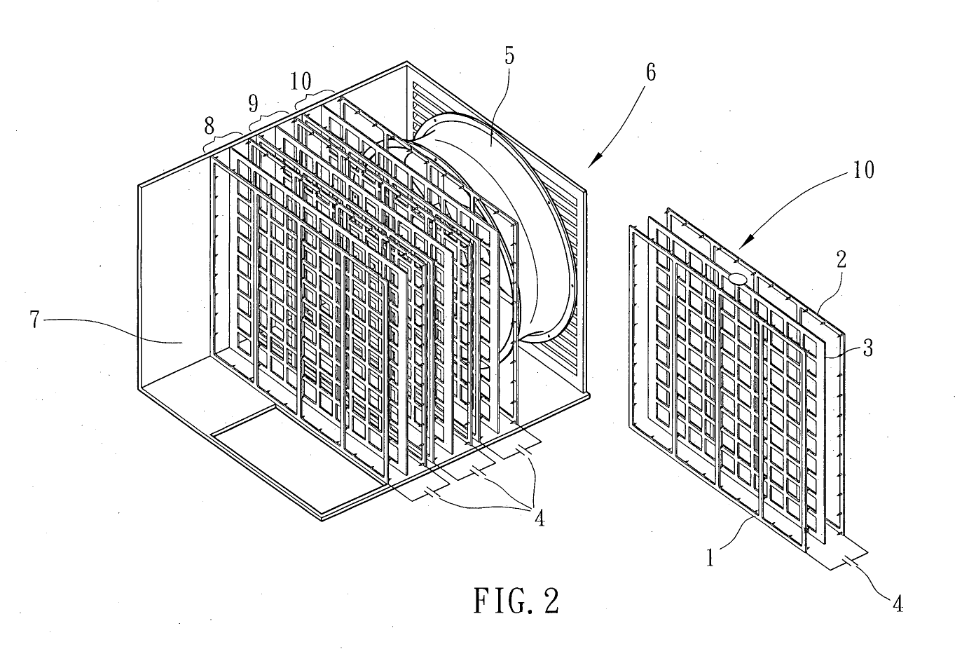

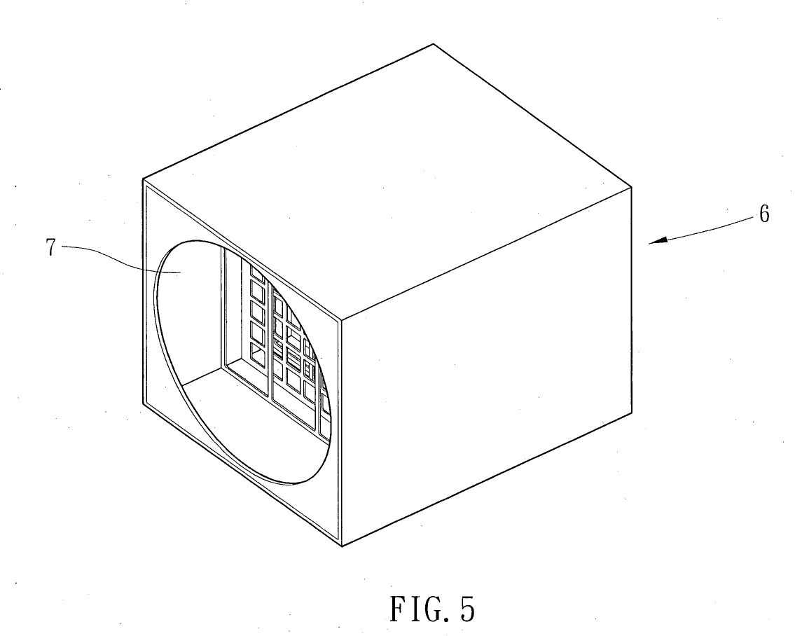

Referring to FIGS. 1, 2 and 5, a dielectric barrier discharge reactor is shown comprising an electrode unit, which is formed of a first electrode panel 1 and a second electrode panel 2, and a meshed treatment unit 3. The meshed treatment unit 3 is set between the first electrode panel 1 and the second electrode panel 2. The first electrode panel 1 and the second electrode panel 2 are connected to a high-voltage power source in one of three methods, i.e., the first method to electrically connect the first electrode panel 1 and the second electrode panel 2 to the positive and negative poles of DC power supply; the second method to electrically connect the first electrode panel 1 and the second electrode panel 2 to the negative pole and grounding terminal of DC power supply; the third method to electrically connect the first electrode panel 1 and the second electrode panel 2 to the positive and negative poles of AC power supply. These three methods achieve the same effects.

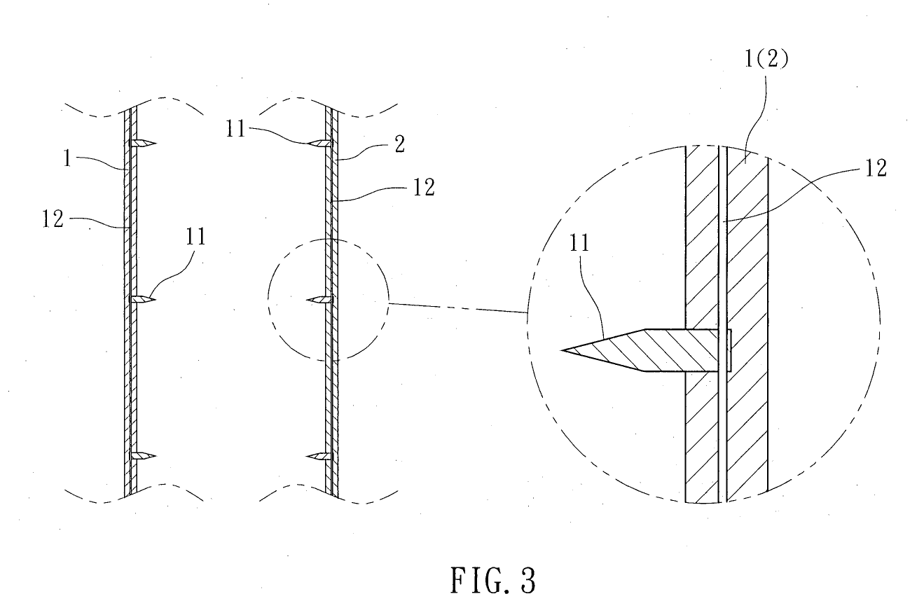

The first electrode panel 1 and the second electrode panel 2 are rectangular open frames of size 10 mm˜5000 mm (height)×10 mm˜5000 mm (width) respectively formed of 1˜20 horizontal rails and 1˜20 vertical columns, as shown in FIG. 3, each having a plurality of metal discharge needles 11 respectively perpendicularly extended from the horizontal rails and vertical columns thereof and spaced from one another at the pitch of 5 mm˜500 mm and a plurality of wire conductors 12 embedded into the horizontal rails and vertical columns and electrically connecting the metal discharge needles 11 in parallel. The horizontal rails and vertical columns of the first electrode panel 1 and the second electrode panel 2 are electrically insulative, avoiding discharge at locations outside the predetermined path and reducing production of ozone. The first electrode panel 1 and the second electrode panel 2 are arranged in vertical in a parallel manner such that the metal discharge needles 11 of the first electrode panel 1 are respectively aimed at the metal discharge needles 11 of the second electrode panel 2.

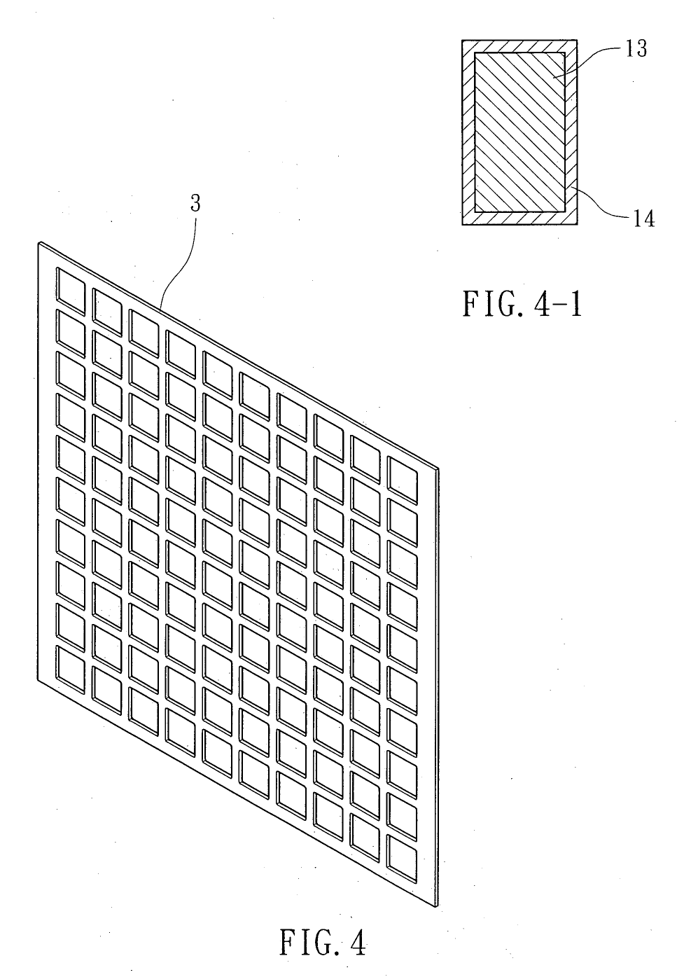

The meshed treatment unit 3 is a flat mesh approximately equal to the size of the first electrode panel 1 and the second electrode panel 2 and set between the first electrode panel 1 and the second electrode panel 2 in a parallel manner and spaced from each of the first electrode panel 1 and the second electrode panel 2 at a gap. As shown in FIG. 4-1, the meshed treatment unit 3 comprises a metal substrate 13 having a thickness about 2 mm˜40 mm, and a metal catalyst 14 prepared from gold, silver, platinum, nickel, manganese, chrome or their combination and coated on the metal substrate 13.

During installation, the positive and negative poles of a high-voltage power source 4 are respectively electrically connected to the first electrode panel 1 and the second electrode panel 2, causing high electric energy to be discharged through the metal discharge needles 11 at the first electrode panel 1 and the respective metal discharge needles 11 at the second electrode panel 2 in a point-to-point manner to ionize harmful substance in the air such as benzene and formaldehyde, causing oxidation of negative ions rapidly. After oxidation, these substances are joined to the air and reduced into oxygen, water and carbon dioxide. Further, an electric field is formed between the two electrode panels 1 and 2. Subject to the induction of the electric field, the metal catalyst 14 at the meshed treatment unit 3 is caused to generate metal ions that are attached to airborne particles (formaldehyde, benzene, ammonia, volatile organic compounds), which are then electrically attracted to a charged collector plate, and therefore the concentration of formaldehyde, benzene, ammonia and many other toxic or harmful volatile organic compounds in the air is greatly reduced. Continuous use of the invention greatly improves the quality of the surrounding air. During point-to-point energy discharge, the metal catalyst 14 of the meshed treatment unit 3 suppresses ozone formation by means of converting the gas to be changed into ozone into negative oxygen ions. Because the oxidization power of negative ions is stronger than ozone, the invention greatly improves decomposition of volatile organic compounds. The area ratio between the cross section of the module of the structural design of the electrode panels 1 and 2 and the meshed treatment unit 3 and the cross sectional area of the air passage allows flowing of a big amount of air through the meshed treatment unit 3 between the two electrode panels 1 and 2. Thus, the applied voltage can be lowered and the air treating capacity can be increased.

The electrode unit of the first electrode panel 1 and the second electrode panel 2 and the meshed treatment unit 3 constitute a dielectric barrier discharge module. Further, three dielectric barrier discharge modules, i.e., a first dielectric barrier discharge module 8, a second dielectric barrier discharge module 9 and a third dielectric barrier discharge module 10 can be arranged with a high-voltage power source 4 and an air flower 5 to constitute an air purifier having an air inlet 6 and an air outlet 7.

When compared to conventional techniques, the invention effectively kills microbes and decomposes and removes volatile organic compounds and also depresses the formation of ozone. The ratio between the cross sectional area of the dielectric barrier discharge module of the two electrode panels 1 and 2 and the meshed treatment unit 3 and the cross sectional area of the air passage allows flowing of a big amount of air through the meshed treatment unit 3 between the two electrode panels 1 and 2. Thus, the applied voltage can be lowered and the air treating capacity can be increased. Therefore, the invention is practical for use in an air purifier to effectively decompose and remove volatile organic compounds.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A dielectric barrier discharge reactor, comprising:
two electrode panels vertically arranged in a parallel manner, each said electrode panel comprising a plurality of metal discharge needles for discharge of a high voltage; and
a meshed treatment unit set between said two electrode panels in a parallel manner and equally spaced from each of said two electrode panels at a predetermined gap.

2. The dielectric barrier discharge reactor as claimed in claim 1, wherein said two electrode panels are rectangular open frames having a plurality of electrically insulative horizontal rails and a plurality of electrically insulative vertical columns connected between said electrically insulative horizontal rails, each said electrode panel having a height about 10 mm˜5000 mm and a width about 10 mm˜5000 mm, each said electrode panel comprising having a plurality of metal discharge needles respectively perpendicularly extended from the electrically insulative horizontal rails and electrically insulative vertical columns thereof and spaced from one another at an equal gap about 5 mm˜500 mm and a plurality of wire conductors embedded in said electrically insulative horizontal rails and said electrically insulative vertical columns and electrically connecting the metal discharge needles in parallel.

3. The dielectric barrier discharge reactor as claimed in claim 1, wherein said two electrode panels are vertically arranged in a parallel manner and spaced by a gap about 10 mm˜500 mm; the metal discharge needles of one said electrode panel are respectively aimed at the metal discharge needles of the other said electrode panel.

4. The dielectric barrier discharge reactor as claimed in claim 1, wherein said meshed treatment unit comprises a substrate having a size equal to said electrode panels, and a metal catalyst prepared from gold, silver, platinum, nickel, manganese, chrome or their combination and coated on said substrate.

5. The dielectric barrier discharge reactor as claimed in claim 1, wherein said two electrode panels are respectively electrically connected to the positive and negative poles of DC power supply.

6. The dielectric barrier discharge reactor as claimed in claim 1, wherein said two electrode panels are respectively electrically connected to the negative pole and grounding terminal of DC power supply.

7. The dielectric barrier discharge reactor as claimed in claim 1, wherein said two electrode panels are respectively electrically connected to the positive and negative poles of AC power supply.

8. The dielectric barrier discharge reactor as claimed in claim 1, wherein said two electrode panels are arranged with said meshed treatment unit to form a module so that multiple same modules are applicable together.
